(19) United States
(12) Patent Application Publication
(10) Pub. No.: US 2011/0195345 A1
(43) Pub. Date: Aug. 11, 2011

(54) Anionic membrane

(76) Inventor: Wilson Hago, Camarillo, CA (US)

(21) Appl. No.: 12/703,054

(22) Filed: Feb. 9, 2010

(51) Int. Cl. H01M 8/02

(52) U.S. Cl. 429/514

(57) ABSTRACT

A separator suitable for alkaline cells or alkaline fuel cells is described that contains on the surface a copolymer of a hydrophobic PTFE component and a hydrophilic PVA-component. This separator resists silver oxidation, peroxide oxidation and provides high hydroxyl conductivity.

In alkaline batteries and fuel cells, separators play a key role in separating cathode and anode. Alkaline fuel cells typically use KOH-saturated asbestos or fiberglass mats. Alkaline batteries, such as silver-zinc cells, typically use regenerated cellulose. [1] Cellulose possesses excellent hydroxyl ion conductivity, and is strong mechanically in a strong alkaline environment. This separator has sometimes been impregnated with silver metal particles to improve performance and decrease separator degradation [2]. Several other attempts have been tried to improve this separator performance, including using high molecular weight [3a-3c], crosslinking with itself and other agents[4], doping with Cu and F ions [5,6], and mixing in hydrophobic agents [7].

Despite significant effort to improve the performance of cellulose-based separators, there are still some drawbacks associated with this separator. Cellulose is a polysaccharide comprised of a linear chain of beta glucose units. In the presence of silver ions and potassium hydroxide solution (KOH), cellulose hydroxyls are oxidized to aldehydic and then to carboxylate units. Eventually this process leads to chain length diminution and film strength degradation accompanied by silver metal deposition on the membrane. Depending on the depth of cycling, this process starts during the first few cycles. Thus a separator is desired that is not easily oxidized by Ag ions. Additionally, a separator is desired that resists oxidation by H₂O₂ since hydrogen peroxide is generated as a result of water oxidation in an alkaline cell. The hydrogen peroxide can decompose into hydroxyl radicals which act to unzip the cellulose chains. [8] H₂O₂ oxidation is also a particular problem in a fuel cell environment if an organic based separator is used. Additionally, present alkaline fuel separators have a problem with hydrogen gas crossover.

It is desired to have a separator that resists oxidation but exhibits high hydroxyl conductivity to meet the power needs of an alkaline cell or alkaline fuel cell. It is also desirable that the separator be mechanically strong so that it can be easily cast. Polyvinyl alcohol (PVA) membranes have been used as a replacement separator for cellulose or as an additional layer in cells containing cellulose separators. [3c] Polyvinyl alcohol needs to be crosslinked in order to render it water insoluble, but this crosslinking removes hydroxyls that aid the conductivity of the membrane. As a consequence, PVA films tend to be an inferior replacement for cellulose films and their use tends to be limited. Furthermore, PVA can also be oxidized by Ag ions in solution [9], though not as easily as cellulose. Radiation grafted polyolefin separators have also been tried [10,11], but the durability of the surface coating is not long term.

The present invention presents a novel non-porous separator that withstands degradation by strong oxidative environments such as H₂O₂ as well as 30-50% KOH electrolyte. It is mechanically strong and shows a comparable conductivity to cellulose and is more resistant to oxidation than cellulose.

### DESCRIPTION OF INVENTION

The novel separator of the present invention is intended for alkaline cells and fuel cells. Sulfonated perfluorinated membranes (trademark Nafion) are regularly used in fuel cell stacks as separators. The perfluorinated component of these membranes provides oxidation resistance against hydrogen peroxide as well as protection against strongly acidic environments. This pertains to the strength of the C—F bond, among the strongest of bonds in chemistry. A perfluorinated component in a separator designed for alkaline cells should accordingly be strongly resistant to cathode oxidation, strongly alkaline environments, and H₂O₂ oxidative environments. A Nafion film by itself would make a poor film for alkaline cells because of the poor ionic conductivity provided by the sulfonate group. It would also be exceedingly expensive because C—F bonds are typically expensive to make.

The basic idea of the present invention is to generate a film that has comparable chemical resistance to Nafion, but has a hydroxyl conductivity comparable to cellulose. The separator of the present invention can be synthesized starting with the commercially available and relatively inexpensive copolymer of PVA and ethylene (poly(vinyl alcohol-co-ethylene)) given by the following formula:

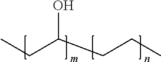

The latter material is easily cast from organic solvents and makes strong films. It is water insoluble. The act of attaching a PVA component to a polyethylene component obviates the need to crosslink the PVA since the copolymer itself is water insoluble. The PVA functionality can be made highly conductive to hydroxyl ions in a similar manner described by Yang and Lin [12], who reported having built a porous polymer electrolyte which is comprised of a mixture of PEO, KOH, PVA and glass fiber mat. It should be noted that their electrolyte is not very water insoluble and is porous so it would be not very applicable to alkaline cells.

The membrane of the present invention is a fluorinated version of PVA-KOH-complex-co-ethylene. An important point is that the membrane is perfluorinated, but only on the surface. C—F bonds are generally expensive to make and they are not really needed in the interior of the membrane. Putting them on the surface contains their cost while at the same time providing for inertness against oxidizing and reducing conditions. The fluorination procedure can be performed following the procedure of Kim et al [13] in the fluorination of a PVA composite. Kim exposed a PVA film to a N₂/F₂ gas mixture in order to accomplish surface fluorination. The fluorination may also be attained by exposing a film to KNiF₆ that is heated to decomposition. Different degrees of fluorination are possible depending on the degree of exposure to fluorine. Accordingly, the polyethylene component may contain one or more of the following polymer segments, described by the formula (CH_{w}FₓCH_{y}yCF_{z}) m where w=0 or 1, x=1 or 2 and y=0 or 1, z=1 or 2 and m=1 to 100000. The PVA-containing component also may contain one or more of the following segments, described by the formula (CHₐF_{b}C(OH_{c}F_{d})HₑF_{f})ₙ where a=0 or 1 and b=1 or 2; c=0 or 1 and d=0 or 1; e=0 or 1 and f=1 or 2; n=1 to 100000. Thus, parts of the separator of the present invention are expected to have the following formula on the surface:

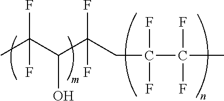

### Example 1

5.0 g PVA-co-ethylene is dissolved in 100 ml N,N dimethyacetamide to make a 5% w/v solution. Add 2 ml of 40% aqueous KOH to the N,N dimethylacetamide solution. The solution is brought to 50-60° C. while stirring. Solution turns light yellow but remains clear. The solution is cast on glass tray that is being kept at 50 C. The solvent is evaporated over a period of several hours. When membrane is dry, it is rinsed in water to detach from glass plate. Film thickness was around 1.5 mils. The resulting membrane is exposed to a gas mixture comprised of 20% F₂/80% N₂ for 30 minutes at room temperature. Membrane was rinsed and wetted on the exterior with KOH. It was placed in an alkaline battery where it exhibited ionic conductivity comparable to cellophane.

Tests were performed to test against chemical oxidation. No visible degradation or mass loss was observed when membrane was left in a concentrated KOH bath for 3 days. Membrane exposed to a concentrated solution of H₂SO₄ did not demonstrate any weight loss, indicating that the PVA-KOH complex embeds the KOH within the PVA matrix. The film was also exposed to 30% H₂O₂ at 50° C. for 16 hours. At the end of the treatment it was noted that the film exhibited no weight loss after the treatment and the film was still intact and flexible.

### REFERENCES

1. Himy, Albert. Silver-zinc battery: Phenomena and design principles. New York: Vantage Press, 1986.
2. U.S. Pat. No. 3,013,099. “Separator for electric batteries”.
3a. Lewis, H. et al. Alternative separation evaluations in model rechargeable silver-zinc cells. Journal of Power Sources 80 (1999) 61-65.
3b. Lewis H. et al. Cellulosic separator applications: new and improved separators for alkaline rechargeable cells. Journal of Power Sources 65 (1997) 29-38.
3c. Lewis, H. et al. Advanced membranes for alkaline primary and rechargeable alkaline cells with zinc anodes. Journal of Power Sources 96 (2001) 128-132.
4. U.S. Pat. No. 7,488,558. “Homogeneous Separator”
5. U.S. Pat. No. 6,682,854 “Battery Separator with fluoride-containing inorganic salt”
6. U.S. Pat. No. 6,558,849. “Battery Separator with copper-containing inorganic salt”
7. U.S. Pat. No. 7,029,792. “Recombinant Separator”
8. Robert, R. et al. Intermediates in wet oxidation of cellulose: identification of hydroxyl radical and characterization of hydrogen peroxide. Water Research 36 (2002) 4821-4829.
9. Fillipo et al. Polyvinyl alcohol) capped silver nanoparticles as localized surface plasmon resonance-based hydrogen peroxide sensor. Sensors and Actuators B: Chemical 138 (2009) 625-630.
10. Karpinski et et al. Silver-zinc: status of technology and applications. Journal of Power Sources 80 (1999) 53-60.
11. U.S. Pat. No. 6,372,379 “Microporous membrane battery separator for silver zinc batteries”
12. C. C. Yang and S. J. Lin. Alkaline composite PEO-PVA-glass-fibre-mat polymer electrolyte for Zn-air battery. Journal of Power Sources 112 (2002) 497-503.
13. Kim et al. Surface fluorinated poly(vinyl alcohol)/poly(styrene sulfonic acid-co-maleic acid) membrane for polymer electrolyte membrane fuel cells. Journal of Membrane Science 342 (2009) 138-144.

1. An anionic membrane exhibiting high hydroxyl conductivity containing on the surface of said membrane: a copolymer comprised of a fluorinated polyethylene component and a PVA-containing component.

2. A membrane according to claim 1 in which the membrane is non-porous.

3. A membrane according to claim 1 in which fluorinated polyethylene component is selected from one of (CH_{w}FₓCH_{y}yCF_{z})m where w=0 or 1, x=1 or 2 and y=0 or 1, z=1 or 2 and m=1 to 100000.

4. A membrane according to claim 1 in which PVA-containing component is selected from one of (CHₐF_{b}C(OH_{c}F_{d})HₑF_{f})n where a=0 or 1 and b=1 or 2; c=0 or 1 and d=0 or 1; e=0 or 1 and f=1 or 2; n=1 to 100000.

5. A membrane according to claim 1 that is resistant to Ag₂O or AgO oxidation.

6. A membrane according to claim 1 that is resistant to H₂O₂ oxidation.

7. A membrane according to claim 1 exhibiting preferably a hydroxyl ionic conductivity between 0.1 and 100 mS/cm.

8. A membrane according to claim 1 in which the PVA-containing component contains KOH.

9. A membrane according to claim 1 in which said membrane is used in an alkaline cell or alkaline fuel cell.

10. A membrane according to claim 1 in which membrane is derived by fluorination of the copolymer PVA-co-ethylene.
